(19) United States
(12) Patent Application Publication
(10) Pub. No.: US 2026/0349312 A1
(43) Pub. Date: Nov. 5, 2026

(54) ENTANGLEMENT DISTRIBUTION OVER TURBULENT FREE-SPACE OPTICAL LINKS USING ADAPTIVE OPTICS WAVEFRONT CORRECTIONS

(71) Applicant: ARIZONA BOARD OF REGENTS ON BEHALF OF THE UNIVERSITY OF ARIZONA, Tucson, AZ (US)

(72) Inventors: Ivan B. Djordjevic, Tucson, AZ (US); Vijay Nafria, Tucson, AZ (US)

(21) Appl. No.: 19/486,357

(22) PCT Filed: May 25, 2024
(86) PCT No.: PCT/US2024/031170

§ 371 Date: Nov. 20, 2025

Related U.S. Application Data
(60) Provisional application No. 63/504,523, filed on May 26, 2023.

(51) Int. Cl. G02F 1/39; H04B 10/70

(52) U.S. Cl. CPC G02F 1/395; H04B 10/70

(57) ABSTRACT

Entanglement is a unique quantum information processing (QIP) feature. Entanglement can be used to implement quantum sensors with improved sensitivity over classical sensors. Disclosed are systems and techniques for entanglement distribution over turbulent free-space optical (FSO) channels based on using adaptive optics. An apparatus can include a C-band tunable laser, amplifier, and periodically poled lithium niobate (PPLN) waveguide for generating entangled photon pairs. The entangled photon pairs are multiplexed with a classical laser beam and transmitted over a free-space optical (FSO) link. A reflected beam from an intermediate node, or a direct beam from a remote transmitter with line-of-sight, is received and provided to an adaptive optics (AO) system using the classical signal as a channel probe to determine a correction. The received beam is further reflected by a deformable mirror to apply the correction. The entangled photon pairs are demultiplexed from the received beam and provided to intended users.

### CROSS-REFERENCE TO RELATED APPLICATIONS

This is a PCT application that claims benefit to U.S. Provisional Application No. 63/504,523, filed May 26, 2023, which is hereby incorporated by reference, in its entirety and for all purposes.

### FIELD

The present disclosure generally relates to quantum information processing (QIP), and in particular, relates to a system and associated method for entanglement distribution over turbulent free-space optical (FSO) links.

### BACKGROUND

Quantum information processing (QIP) opens new avenues for numerous applications, including high-performance computing, high-precision sensing, and secure communications. Among various QIP attributes, entanglement is a unique QIP feature and may be used to implement quantum computers capable of solving problems that are numerically intractable for classical computers. Entanglement-based approaches may also lead to quantum-enhanced sensors with measurement sensitivities that exceed classical limits.

For example, entanglement represents a unique quantum information processing (QIP) attribute that can enable: (1) outperforming classical sensor sensitivity; (2) unconditional security for future communication networks; and (3) exceeding classical channel capacities. Additionally, pre-shared entanglement can enable distributed quantum sensing and/or secure distributed quantum computing. In some cases, entanglement can be seen to enable quantum sensors with a sensitivity better than the standard quantum limit, communications with a spectral efficiency greater than the Shannon limit, secure communication with security guaranteed by the QIP theorems, distributed quantum sensing, and secure distributed quantum computing, among various others.

To utilize unique capabilities of entanglement, quantum communication links can be used to distribute entanglement to remote nodes. To distribute entanglement, fiber-optic based links can be used. In some examples, to enable wider area and/or global coverage, entanglement can be distributed by satellite-to-ground links. However, satellite-to-ground links may introduce relatively long propagation delays.

It is with these observations in mind, among others, that various aspects of the present disclosure were conceived and developed.

### SUMMARY

The present disclosure provides a number of examples of an inventive concept including systems and methods for entanglement distribution over turbulent free-space optical (FSO) links and/or other atmospheric channels. In the context of the disclosed methods, devices, techniques, apparatus, systems, and so on, the terms “operable to,” “configured to,” and “capable of” used herein are interchangeable.

In one illustrative example, an apparatus is provided, the apparatus comprising: a tunable laser configured to generate a beam at a first wavelength; an amplifier connected to an output of the tunable laser, wherein the amplifier generates as output an amplified beam at the first wavelength and with an increased power; and a periodically poled lithium niobate (PPLN) waveguide configured to receive the amplified beam from the amplifier and generate one or more entangled pairs of photons, each entangled pair of photons comprising a signal photon and an idler photon, wherein the PPLN waveguide generates the one or more entangled pairs of photons using spontaneous parametric down-conversion (SPDC).

In some aspects, the tunable laser comprises a C-band laser diode and the amplifier comprises an Erbium-Doped Fiber Amplifier (EDFA).

In some aspects, the first wavelength is associated with a combination of the tunable laser and the EDFA and is equal to 1548.97 nanometers (nm); the signal photon has a wavelength of 1510 nm; and the idler photon has a wavelength of 1590 nm.

In some aspects, the PPLN waveguide includes one or more graded index lenses on a first side and a second side of the PPLN waveguide; and the one or more graded index lenses are configured to provide a coupling to polarization maintaining fibers without using a fiber-to-crystal coupling.

In some aspects, a first half of the PPLN waveguide along its longitudinal length is used to perform wavelength conversion of the amplified beam; and a second half of the PPLN waveguide along the longitudinal length is used to perform the SPDC.

In some aspects, the apparatus further comprises: a second laser configured to generate a second beam at a second wavelength, wherein the second wavelength differs by a configured amount from the first wavelength associated with the tunable laser; a multiplexer configured to generate a multiplexed signal based on combining a classical signal comprising the second beam at the second wavelength with a quantum signal comprising an output from the PPLN waveguide at the first wavelength of the tunable laser; and an optical transmitter for transmitting a beam including the multiplexed signal generated by the multiplexer.

In some aspects, the multiplexed signal comprises a beam that includes a classical component corresponding to the classical signal and a quantum component corresponding to the quantum signal.

In some aspects, the second wavelength is 1310 nanometers (nm).

In some aspects, the multiplexer implements wavelength-division multiplexing (WDM).

In some aspects, the apparatus further comprises: a receiver for receiving one or more of a reflected beam from an intermediate node, or a receive beam from a transmitter; wherein the reflected beam comprises a reflection of the transmitted beam by a mirror or reflector located at the intermediate node, which for example may be applicable when there is no line-of-sight between the transmitter and the receiver.

In some aspects, the receive beam comprises the transmitted beam from the optical transmitter after propagation over a turbulent free-space optical (FSO) channel between the optical transmitter and the receiver.

In some aspects, the receiver comprises a periscope and a compressing telescope, and wherein the periscope is included in the optical transceiver.

In some aspects, the apparatus further comprises: an adaptive optics (AO) sub-system, wherein the AO sub-system receives a portion of the reflected beam from the intermediate node or a direct beam from a remote transmitter and determines a correction for applying to a deformable mirror to compensate for turbulence on a free-space optical (FSO) link between the optical transmitter and the optical receiver; and a deformable mirror, wherein the deformable mirror is controllable to receive a remaining portion of the reflected beam and deform based on the correction determined by the AO sub-system, and wherein the deformation of the deformable mirror generates a compensated reflected beam.

In some aspects, the AO sub-system includes a wavefront sensor (WFS), the deformable mirror, and a computing device; and the WFS and the deformable mirror operate in a feedback servo loop.

In some aspects, the apparatus further includes: a first demultiplexer configured to separate the classical signal component of the compensated reflected beam from the quantum signal component of the compensated reflected beam; a second demultiplexer configured to separate the entangled photons of the quantum signal component; and one or more detectors for detecting each separated entangled photon.

In some aspects, the first demultiplexer comprises a wavelength-division (WDM) demultiplexer; the second demultiplexer comprises a two-stage compact coarse WDM (CCWDM) demultiplexer; and the one or more detectors are correlated single photon detectors (SPDs).

In some aspects, an operating wavelength of the tunable laser is selected: based on a tunable pump wavelength, a signal photon wavelength, and an idler photon wavelength; or according to 2/λₚ=1/λₛ+1/λᵢ, where λₚ is a tunable pump wavelength, λₛ is a signal photon wavelength, and λᵢ is an idler photon wavelength. In some examples, the roles of signal and idler photons can be swapped.

In some aspects, the idler photon wavelength (λᵢ) is 1510 nanometers (nm) and the signal photon wavelength (λₛ) is 1590 nm; and the tunable pump wavelength is determined as 1548.97 nm based on the idler photon wavelength and the signal photon wavelength.

In some aspects, the tunable laser includes a tunable pump that can be used to generate multi-wavelength entangled pairs.

In some aspects, the tunable laser includes a tunable pump that can be used to generate multi-wavelength entangled pairs, wherein the tunable pump wavelength of 1549.75 nm and idler photon wavelengths of 1510 nm and 1530 nm are used to determine signal photon wavelengths of 1591.65 nm and 1570 nm, respectively.

In some aspects, the tunable pump wavelength of 1548.97 nm and an idler photon wavelength of 1568 nm are used to determine a signal photon wavelength of 1530.39 nm. In some examples, the tunable pump wavelength of 1549.75 nm and idler photons wavelengths of 1510 nm and 1530 nm are used to determine signal photons wavelengths of 1591.65 nm and 1570 nm, respectively.

The foregoing examples broadly outline various aspects, features, and technical advantages of examples according to the disclosure in order that the detailed description that follows may be better understood. It is further appreciated that the above operations described in the context of the illustrative example method, device, and computer-readable medium are not required and that one or more operations may be excluded and/or other additional operations discussed herein may be included. Additional features and advantages will be described hereinafter. The conception and specific examples illustrated and described herein may be readily utilized as a basis for modifying or designing other structures for carrying out the same purposes of the present disclosure. Such equivalent constructions do not depart from the spirit and scope of the appended claims.

### BRIEF DESCRIPTION OF THE DRAWINGS

FIG. 1 is a simplified diagram showing an example entanglement distribution system that can be used to perform entanglement distribution over turbulent channels and/or free-space optical (FSO) links, in accordance with some examples;

FIG. 2 is a simplified diagram showing another example of an entanglement distribution system with adaptive optics for entanglement distribution over turbulent channels and/or FSO links, in accordance with some examples;

FIG. 3A is a graph showing coincidence counts at different time instances for two PPLN input powers in a strong turbulence regime, in accordance with some examples;

FIG. 3B is a graph showing a histogram of power fluctuations at the end of a 1.5 kilometer free-space optical (FSO) link, in accordance with some examples;

FIG. 3C is a graph showing coincidence counts recorded on CSPD with and without application of adaptive optics over turbulent channels, in accordance with some examples;

FIG. 4 is a simplified diagram showing an example of an entanglement distribution system that can be used to perform multipartite entanglement distribution over turbulent channels of an FSO link, in accordance with some examples;

FIG. 5A is a graph showing coincidence count measurement results for 1510 nm-1590 nm entangled photon pairs after 1.45 km propagation over a turbulent FSO link, in accordance with some examples;

FIG. 5B is a graph showing coincidence count measurement results for 1530 nm-1570 nm entangled photon pairs after 1.45 km propagation over a turbulent FSO link, in accordance with some examples; and

FIG. 6 is a graph showing a distribution of received power at 1310 nm, in accordance with some examples.

Corresponding reference characters indicate corresponding elements among the view of the drawings. The headings used in the figures do not limit the scope of the claims.

### DETAILED DESCRIPTION

Aspects of the present disclosure provide systems and methods for distributing quantum entanglement over turbulent free-space optical (FSO) links. In one illustrative example, an entanglement distribution system can include adaptive optics (AO) configured to compensate for atmospheric turbulence and/or other scattering effects that may be present in terrestrial FSO links used to transmit quantum information via entangled photons. For example, adaptive optics can provide wavefront corrections to improve entanglement distribution (e.g., improve the fidelity of entanglement) when entangled states are distributed over turbulent FSO links.

Entanglement is a key quantum information processing (QIP) feature enabling quantum communication, networking, and sensing (among various others). For example, in quantum communication techniques, information may be transmitted using quantum states of photons. Entanglement is a quantum phenomenon where two or more particles (e.g., two or more photons, etc.) are correlated such that the state of one particle cannot be described independently of the others. Entangled particles such as photons can theoretically be used to transmit quantum information over very long distances. However, functional limits on the maximum reliable or useful range of entanglement distribution can arise due to physical limitations and losses associated with the transmission of photons through a medium (e.g., such as optical fibers, free-space optical links, satellite links, etc.).

For example, long-distance quantum communication is affected by the photon loss associated with the photons traveling through a medium such as optical fiber. As the photons travel through the medium, some of the photons may be lost due to various factors such as absorption, scattering, and/or imperfections in the transmission channel. The “photon loss” can refer to or quantify the loss of photons over the transmission channel (e.g., along the path from the transmitter to the receiver). Moreover, unlike classical signals, quantum signals cannot be amplified without disturbing their information-bearing entangled quantum state. In particular, quantum signals cannot be amplified without introducing additional noise that degrades or even destroys the transmitted entanglement.

As such, the classical signal transmission approach of amplifying weak signals to compensate for the loss cannot be utilized for quantum communications, and the photon loss can limit the distance over which quantum information can be reliably transmitted. The longer the transmission distance, the greater the photon loss and the weaker the quantum signal becomes at the receiver, which can decrease the fidelity and success rate of quantum communications and/or quantum information transmission. Quantum communication techniques may therefore require fundamentally distinct loss-mitigation mechanisms to establish long-range entanglement.

As an alternative, free-space optical (FSO) links can be used instead for performing the underlying entanglement distribution needed for quantum communication and/or quantum information transmission. FSO links can be implemented based on using light propagating in free space to transmit information between two points. For example, rather than using optical fibers or waveguides to guide the light signal, FSO-based communication techniques allow photons to propagate in free space between the transmitter and the receiver, using the atmosphere as the transmission medium. However, FSO links can be strongly affected (e.g., limited) by the presence or occurrence of atmospheric turbulence effects, in addition to scattering effects and/or various other atmospheric conditions or behaviors that can reduce the signal quality and performance of FSO links.

Systems, apparatuses, processes (also referred to as methods), and computer-readable media (collectively referred to as “systems and techniques”) are described herein that can be used to perform entanglement distribution over turbulent free-space optical links. For example, the systems and techniques can use adaptive optics configured to provide wavefront corrections to improve the fidelity of entanglement when entangled states are distributed over turbulent FSO links. Further described are results from FSO communication experiments where entangled photon pairs were generated, launched into free-space, and later collected for coincidence count measurements. It is demonstrated that adaptive optics can be used to make improvements in coincidence counts, and therefore, that adaptive optics can be used to improve entanglement distribution, particularly over turbulent FSO links.

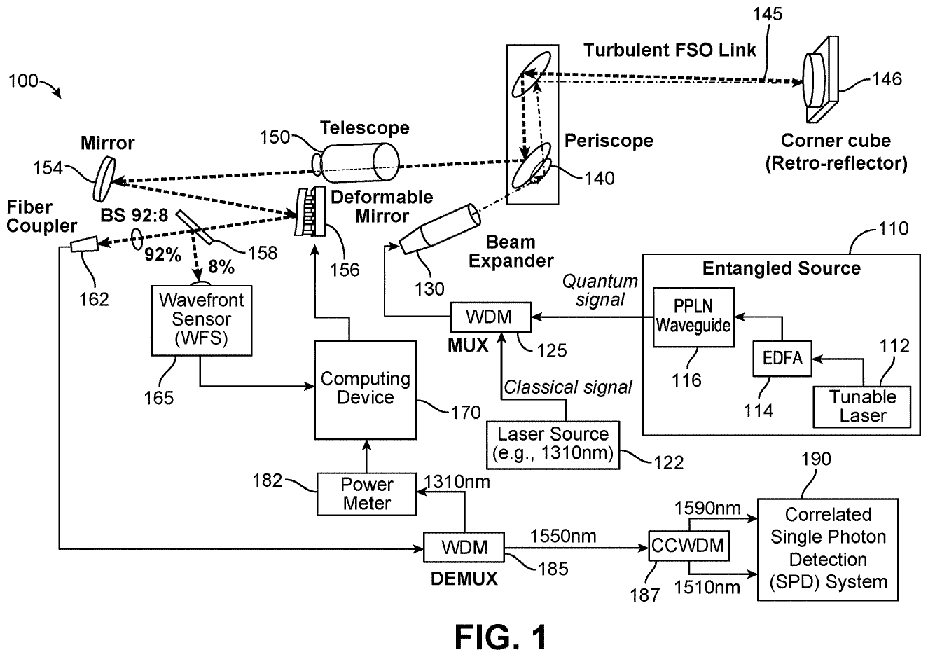

The systems and techniques described herein can be used to provide entanglement distribution for various wavelengths and quantities of different wavelengths. For example, FIGS. 1-3C correspond to examples where entangled photons are generated at two wavelengths (e.g., 1510 nm and 1590 nm, although it is noted that different combinations of wavelengths can also be utilized without departing from the scope of the present disclosure). Entangled photons generated at two wavelengths can also be referred to as a single entangled photon pair. For example, the photons generated at 1510 nm and 1590 nm comprise a single entangled photon pair.

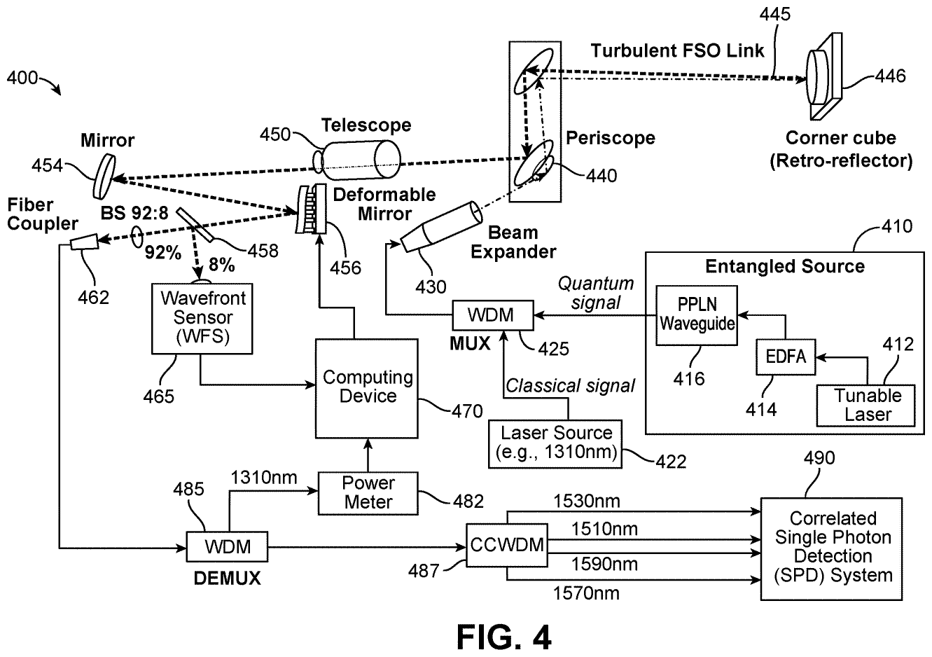

FIGS. 4-6 correspond to examples of multi-wavelength entanglement distribution (e.g., multipartite entanglement distribution), where two or more entangled photon pairs are generated. In the example entanglement distribution system of FIGS. 4-6, two entangled photon pairs are generated using four different wavelengths. A first entangled photon pair is generated at the 1530 nm and 1570 nm wavelengths; a second entangled photon pair is generated at the 1510 nm and 1590 nm wavelengths. It is noted that the example of four entangled photons (two entangled photon pairs) is provided for purposes of illustration and example and is not intended to be limiting, as a greater quantity of entangled photons and/or entangled photon pairs can be utilized without departing from the scope of the present disclosure.

The discussion below refers first to FIGS. 1-3C and the example of entanglement generation and distribution for a single entangled photon pair. Multipartite entanglement generation and distribution are subsequently discussed with respect to FIGS. 4-6 and the example of two entangled photon pairs.

Described below is an example of successful entanglement distribution demonstrated over a free-space optical (FSO) link in a strong turbulence regime, using the example entanglement distribution system 100 of FIG. 1. In particular, FIG. 1 is a simplified diagram showing an example entanglement distribution system 100 that can be used to perform entanglement distribution over turbulent channels and/or FSO links, based on utilizing adaptive optics and/or wavefront connections to the transmitted photons. In some aspects, the entanglement distribution system 100 can also be referred to as an “FSO testbed system” for entanglement distribution over turbulent channels.

The systems and techniques described herein can provide a low-cost solution that can be configured to generate entangled photons using an entangled source 110. In one illustrative example, the entangled source 110 includes a tunable laser 112 (e.g., a C-band laser diode), an Erbium-Doped Fiber Amplifier 114, and a periodically poled lithium niobate (PPLN) waveguide 116. Wavelength conversion followed by spontaneous parametric down-conversion can take place in the PPLN waveguide 116. In some aspects, the combination of the tunable laser 112, the EDFA 114, and the PPLN waveguide 116 (e.g., the entangled source 110) can also be referred to as a “PPLN-waveguide based entangled source.”

In some examples, the example entanglement distribution system 100 (e.g., FSO testbed system 100) can comprise the PPLN-waveguide based entangled source 110, an optical transceiver system, an FSO link 145 affected by turbulence, and a correlated single photon detection system 190. Signal-idler entangled photon pairs can be generated using a properly designed and fabricated PPLN waveguide. For example, the signal-idler entangled photon pairs can be generated as (or included within) the “quantum signal” shown at the output of the PPLN waveguide 116/entangled source 110 of FIG. 1. In one illustrative example, the tunable laser 112 can comprise a C-band laser diode, which coupled to the EDFA 114 can produce a 1548.97 nm CW output that is fed to the PPLN waveguide 116. The PPLN waveguide 116 can perform wavelength conversion to obtain a 774.485 nm secondary pump signal that is subsequently used to further generate entangled photons at 1510 nm and 1590 nm by a spontaneous parametric down-conversion process of the PPLN waveguide 116. It is noted that a conventional approach would require a significantly more expensive 780 nm laser pump and a PPLN crystal, as compared to the relatively low-cost solution provided by the entangled source 110 of FIG. 1, based on the C-band tunable laser diode 112, EDFA 114, and PPLN waveguide 116.

Subsequently, the quantum signal output from the PPLN waveguide 116 can be multiplexed with a classical laser signal generated by a second laser source 122 (e.g., via the multiplexing operation “MUX” shown in FIG. 1). In one illustrative example, the classical laser signal generated by the second laser source 122 can be a 50 mW 1310 nm laser signal, shown in FIG. 1 as the “classical signal” at the output of the laser source 122. The second laser source 122 associated with generating the classical signal can be separate from the tunable C-band laser diode 112 that is included within the entangled source 110 and used to generate the quantum signal as described above. In some embodiments, the multiplexer used to combine (e.g., multiplex) the quantum signal and the classical signal can be implemented as a wavelength division multiplexer (WDM) 125, where the WDM 125 is configured to perform wavelength division multiplexing of the quantum signal output from the PPLN waveguide 116 with the classical 1310 nm laser signal from the laser source 122. In some examples, the classical 1310 nm laser signal and the laser source 122 can be used by the entanglement distribution system 100 for alignment purposes and to operate the adaptive optics subsystem, as will be described in greater depth below. Other signal powers (e.g., other than 50 mW in the example above) and/or wavelengths (e.g., other than 1310 nm) of the classical laser signal generated by the second laser source 122 are applicable as well.

In the example experimental setup associated with the FSO testbed entanglement distribution system 100 of FIG. 1, the multiplexed WDM signal (e.g., the output from the WDM multiplexer 125) is then launched into free space towards a corner-cube retroreflector or mirror 146 which is ~750 meters away, using a beam expander 130 and periscope 140 provided on a first end of a turbulent FSO link 145. The second end of the turbulent FSO link 145 can be located at the corner-cube retroreflector 146 (as used herein, the retroreflector 146 may be interchangeably referred to as a mirror 146, and vice versa). The turbulent FSO link 145 can correspond to a line-of-sight (LOS) path between the beam expander 130/periscope 140 and the corner cube retroreflector 146. In some aspects, a purpose of using the corner-cube retroreflector 146 can be to double the transmission distance of the entangled photon pairs (e.g., as the total transmission distance of the FSO testbed configuration shown in FIG. 1 is equal to two times the length of the FSO link 145, based on the photons being transmitted over the FSO link 145 from the periscope 140 to the corner cube retro-reflector 146, and then being reflected back to the periscope 140 by the corner cube retro-reflector 146 over the same FSO link 145).

Alternatively, a mirror or reflector (e.g., such as the retroreflector/mirror 146, etc.) can be used to point the reflected beam towards the receiver, for example in scenarios or configurations when a direct line-of-sight is not available between the transmitter and the reflector. For instance, two communicating parties may be located on opposite sides of a mountain such that the mountain blocks the LOS between the two communicating parties. The two communicating parties can communicate using an intermediate node or relay configured with a mirror or reflector (e.g., mirror/reflector 146, etc.) that has a direct LOS to the transmitter (e.g., a first communicating party of the pair) and also has a direct LOS to the receiver (e.g., a second communicating party of the pair), where the mirror or reflector is used to relay or redirect transmissions between the transmitter/transmitting party and the receiver/receiving party. In some aspects, the intermediate node or relay can comprise or otherwise utilize a mirror or reflector that is provided on a drone or other aerial vehicle, that is provided on a movable or repositionable device or system, etc. In such examples, the drone, aerial vehicle, movable or repositionable device, etc., used to provide the intermediate/relay node can move between a plurality of different intermediate relay positions with LOS to one or more (or both) of the transmitter and the receiver, to thereby distribute entangled photons between the transmitter and the receiver.

For example, the transmitted beam from the beam expander 130 and periscope 140 then gets reflected back towards the receive side of the entanglement distribution system 100 by a corner-cube retroreflector 146 that is placed on the rooftop of a distant target. The transmitted beam and the reflected beam from the corner-cube retroreflector 146 both travel the same turbulent FSO link 145. The reflected beam from the corner-cube retroreflector 146 can be collected using the periscope 140 and a telescope 150. In one illustrative example, the telescope 150 can be a compressing telescope.

From the periscope 140 and compressing telescope 150, a first mirror 154 can be used to reflect the received signal to a deformable mirror 156 that is coupled to a computing device 170 for controlling the adaptive optics (AO) of the deformable mirror 156, as will be described in greater depth below. In the example of FIG. 1, the thin arrows with a ‘—.—.—’ pattern represent a transmitting direction (e.g., a transmitted beam) of the entanglement distribution system 100, and the thick arrows with a ‘----’ pattern represent a receiving direction (e.g., a received/reflected beam) of the entanglement distribution system 100. Similarly, the periscope 140 can include multiple mirrors distributed generally to the top and the bottom of the periscope 140 and configured for use in either the transmit side/transmit path of the periscope 140, the receive side/receive path of the periscope 140, or both.

An adaptive optics (AO) stage of the entanglement distribution system 100 can include the deformable mirror 156 and a wavefront sensor (WFS) 165 operating in a feedback servo loop controlled at least in part by the computing device 170. From the deformable mirror 156, the reflected beam can be provided to a beam splitter 158 configured to split the reflected beam into a first reflected beam portion (e.g., provided to a fiber coupler 162) and a second reflected beam portion (e.g., provided to the WFS 165). In some aspects, the beam splitting ratio implemented by the beam splitter 158 can be 92:8, although various other beam splitting ratios and/or beam splitter configurations can also be utilized. In the example of beam splitter 158 being implemented as a 92:8 beam splitter, the first reflected beam portion provided from the beam splitter 158 to the fiber coupler 162 can comprise approximately 92% of the photons or power represented within the full reflected beam output from the deformable mirror 156. The second reflected beam portion provided from the beam splitter 158 to the WFS 165 can comprise approximately 8% of the photons or power represented within the full reflected beam output from the deformable mirror 156.

In some embodiments, the first reflected beam portion after the beam splitter 158 (e.g., the 92% beam portion) is coupled into a fiber (e.g., fiber optic line) using the fiber coupler 162 for downstream processing by the WDM demultiplexer 185, while the second portion of the beam reflected from the deformable mirror 156 (e.g., the 8% beam portion from the beam splitter 158) is used by the WFS 165 to measure the distortions in the wavefront introduced by the turbulent channel of the FSO link 145. In one illustrative example, a correction algorithm (e.g., AO and/or wavefront correction algorithm, etc.) is run on the computing device 170, based on using the output measurements of the WFS 165 to determine corresponding forces to be applied by the actuators of the deformable mirror 156 in order to undo (e.g., correct or compensate) the turbulent action of the channel 145.

Classical signals (e.g., the portion of the beam reflected by the deformable mirror 156 that corresponds to the classical laser signal from the second laser source 122) and quantum signals (e.g., the portion of the beam reflected by the deformable mirror 156 that corresponds to the quantum signal from the PPLN waveguide 116/entangled source 110) can be separated out from the reflected beam using a 1310 nm-1550 nm WDM demultiplexer 185. For example, the WDM demultiplexer 185 can be coupled to the opposite end of the fiber line from the fiber coupler 162, and can thereby receive the 92% beam portion from the beam splitter 158. The WDM demultiplexer 185 can correspond to the WDM multiplexer 125, and can be configured to undo or reverse the multiplexing operation(s) applied previously by the WDM multiplexer 125.

For example, the WDM demultiplexer 185 can generate as output a first demultiplexed signal portion at 1310 nm, corresponding to the classical signal from the second laser source 122, and can further generate as output a second demultiplexed signal portion at 1550 nm, corresponding to the quantum signal from the PPLN waveguide 116/entangled source 110. The 1310 nm demultiplexed signal portion can be provided from the WDM demultiplexer 185 to a power meter 182 coupled to the same computing device 170 that is used to control the adaptive optics implemented by the deformable mirror 156. In one illustrative example, the 1310 nm demultiplexed signal portion from the WDM demultiplexer 185 can be used to provide the 1310 nm CW classical signal used by the entanglement distribution system 100 to perform both the beam alignment and the adaptive optics operation. For instance, the computing device 170 can use the power meter 182 to measure the 1310 nm CW classical signal from the demultiplexer 185, where the computing device 170 further uses the readings from the power meter 182 to determine beam alignment information for controlling, configuring, and/or adjusting the adaptive optics of the deformable mirror 156.

The second demultiplexed signal portion generated as output by the WDM demultiplexer 185 can be the portion of the reflected beam corresponding to the entangled photon pair(s) of the quantum signal from the PPLN waveguide 116/entangled source 110. The 1550 nm signal is further demultiplexed by a two-stage CCWDM (compact coarse WDM) demultiplexer 187 that is provided downstream from the WDM demultiplexer 185 and is configured to separate 1510 nm and 1590 nm entangled photon pairs from the quantum signal portion of the output of the WDM demultiplexer 185.

In this manner, the entanglement distribution system 100 can obtain >100 dB isolation of the quantum signals. The quantum outputs of the two-stage CCWDM demultiplexer 187 (e.g., the separated 1510 nm and 1590 nm entangled photon pairs) can be fed to two separate single-photon detectors of a correlated single photon detection (SPD) system 190 that can be used to measure the coincidence counts. For example, the correlated SPD system 190 can include a first single-photon detector corresponding to the separated 1590 nm entangled photon pairs from the CCWDM demultiplexer 187, and can include a second single-photon detector corresponding to the separated 1510 nm entangled photon pairs from the CCWDM demultiplexer 187.

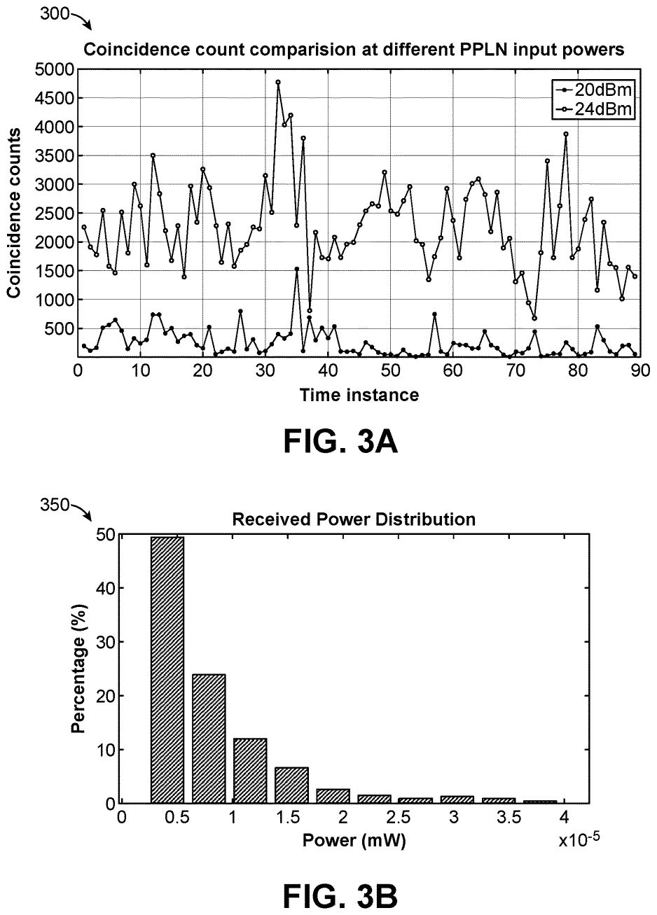

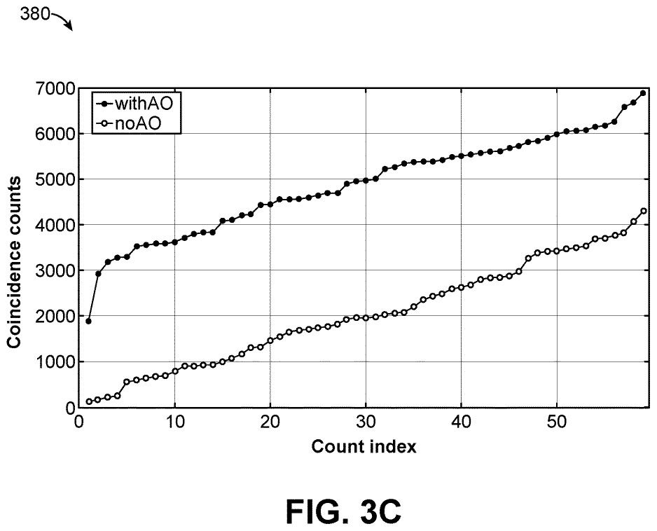

FIG. 3A is a graph 300 showing coincidence counts at different time instances for two PPLN input powers in a strong turbulence regime, in accordance with some example. For instance, the graph 300 of FIG. 3A depicts coincidence count measurements results for two different input powers to a PPLN waveguide, such as the PPLN waveguide 116 of FIG. 1, at different instances of times. By increasing the PPLN input power from 20 dBm to 24 dBm, the coincidence counts can be significantly improved. The coincidence count measurements are performed in the presence of turbulence (e.g., on the FSO link 145), with a corresponding histogram of power fluctuation depicted in FIG. 3B as a received power distribution histogram 350 for power fluctuations at the end of a 1.5 km FSO link (e.g., where the 1.5 km FSO link corresponds to the round trip distance of the ~750 m FSO link 145 of FIG. 1). Given that the distribution of collected power (e.g., in the 1310 nm channel) is exponential, the results shown in FIGS. 3A and 3B indicate that the distribution of entanglement is possible even in the beyond strong turbulence channels.

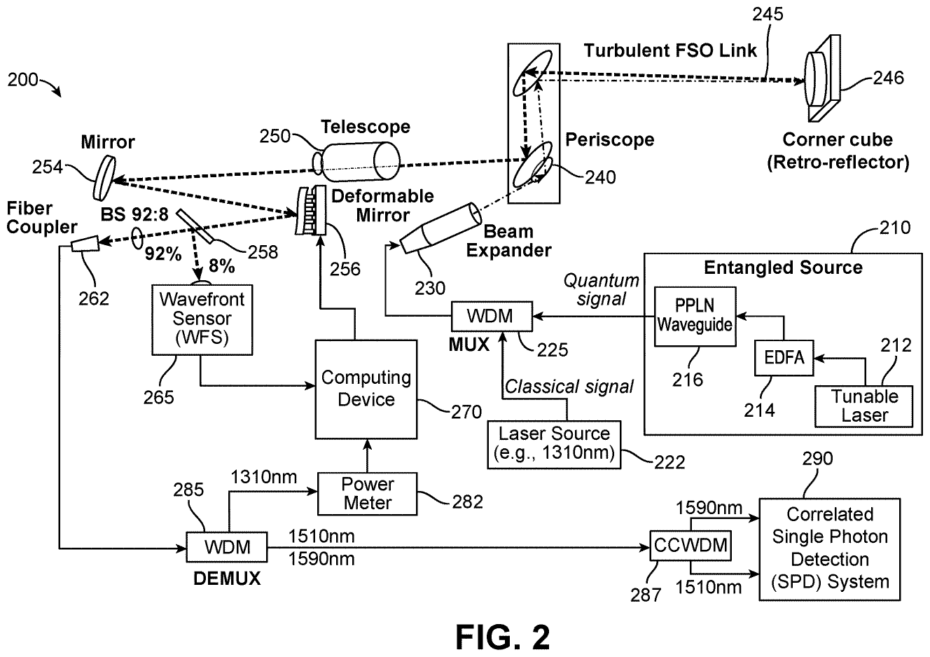

FIG. 2 is a simplified diagram showing another example of an entanglement distribution system 200 (e.g., an FSO optical setup or testbed) with adaptive optics (AO) that can be used to perform entanglement distribution over turbulent channels and/or FSO links, in accordance with some examples.

In some embodiments, the entanglement distribution system 200 of FIG. 2 can be the same as or similar to the entanglement distribution system 100 of FIG. 1. In some cases, FIGS. 1 and 2 can correspond to the same entanglement distribution system or FSO testbed. In some cases, the multipartite entanglement generation and distribution system 400 depicted in FIG. 4 and described below can additionally be the same as or similar to one or more portions or components included in the entanglement distribution system 100 of FIG. 1 and/or the entanglement distribution system 200 of FIG. 2. Namely, the parametric down conversion process is a very wideband process so that a large number of entangled wavelength pairs can be used to distribute the entanglement.

In one illustrative example, the entanglement distribution system 200 of FIG. 2 can correspond to an FSO entanglement distribution testbed or experimental setup comprising four stages. A first stage can be used for generation of entangled photon pairs; a second stage can be used for transmitting and receiving entangled photon pairs on a 1.5 km long free-space optical link; a third stage can be used for azimuthal phase compensation and correction using adaptive optics; and a fourth stage can be used to obtain measurements for coincidence counts. In particular, it is noted that FIG. 2 is a simplified example block diagram of an experimental setup for an entanglement distribution system 200 that can be used to implement aspects of the present disclosure. In some cases, the block diagram of FIG. 2 can be the same as or similar to that of FIG. 1, and components having the same names or labels across the two figures may be the same as or similar to one another. For example, the entangled source 210 of FIG. 2 (e.g., including the tunable laser 212, the EDFA 214, and the PPLN waveguide 216) can be the same as or similar to the entangled source 110 of FIG. 1 (e.g., including the tunable laser 112, the EDFA 114, and the PPLN waveguide 116), and may be used to generate entangled photon pairs.

In one illustrative example, the entangled source 210 can include a PPLN waveguide 216 that can be used to generate signal-idler photon pairs at 1510 nm and 1590 nm through a process of spontaneous parametric down-conversion (SPDC) by using a C-band laser at 1548.97 nm (e.g., the tunable laser 212) and an EDFA 214. In some aspects, the PPLN waveguide 216 of FIG. 2 can be the same as or similar to the PPLN waveguide 116 of FIG. 1; the tunable laser 212 of FIG. 2 can be the same as or similar to the tunable laser 112 of FIG. 1; the EDFA 214 of FIG. 2 can be the same as or similar to the EDFA 114 of FIG. 1; etc.

To generate the entangled signal-idler photon pairs used by the entanglement distribution system 200 of FIG. 2, in the first half of the PPLN waveguide 216 (e.g., the first half of the PPLN waveguide 216 along its longitudinal length) wavelength conversion is performed. In the second half of the PPLN waveguide 216 (e.g., the second half of the PPLN waveguide 216 along the same longitudinal length), the SPDC process takes place. In some cases, the PPLN waveguide 216 can be sufficiently long such that in the first half of its longitudinal length, second harmonic generation takes place, so that secondary pump is obtained. In the second half of the PPLN waveguide 216, the secondary pump (e.g., from the first half of the PPLN waveguide 216) is used to generate the entangled photons by the spontaneous parametric down-conversion process.

Following the generation of entangled photon pairs in the first stage of the entanglement distribution system 200 (e.g., where the first stage is provided by the entangled source 210 comprising the tunable laser 212, EDFA 214, and PPLN waveguide 216), the entanglement distribution system 200 can multiplex the entangled photon pairs (e.g., the “quantum signal” of FIG. 2) with a 50 mW 1310 nm classical laser beam (e.g., the “classical signal” of FIG. 2) for the purpose of alignment and adaptive optics operation. In some aspects, the multiplexing of the quantum signal and the classical signal can be performed using a WDM multiplexer 225, which can be the same as or similar to the WDM multiplexer 125 of FIG. 1. In some cases, the WDM multiplexer 225 of FIG. 2 can be the same as or similar to the WDM multiplexer 125 of FIG. 1, but operated in the reverse direction. The 1310 nm classical laser beam shown as the classical signal in FIG. 2 can be generated by a laser source 222, which can be the same as or similar to the second laser source 122 of FIG. 1.

The entanglement distribution system 200 can then launch (e.g., transmit, etc.) the multiplexed beam from the WDM multiplexer 225 into free-space towards a corner-cube retroreflector 246 that is approximately 750 meters away. The corner-cube retroreflector 246 can be the same as or similar to the corner-cube retroreflector 146 of FIG. 1, and may be interchangeably referred to as a mirror 246 and/or a reflector 246. The multiplexed beam can be passed from the WDM multiplexer 225 to a beam expander 230 and a periscope 240, which may be the same as or similar to the beam expander 130 and the periscope 140 (respectively) of FIG. 1. In some examples, the turbulent FSO link 245 of FIG. 2 can be the same as or similar to the turbulent FSO link 145 of FIG. 1.

The example distance of ~750 m for the turbulent FSO link 245 is provided for illustrative purposes, and it is noted that various other distance(s), greater or lesser than 750m, may also be utilized without departing from the scope of the present disclosure. The transmitted light beam transmitted by the combination of the WDM multiplexer 225, beam expander 230, and periscope 240 propagates or travels over the turbulent FSO link 245 before being returned back to the entanglement distribution system 200 by a corner-cube retroreflector 246 placed on rooftop or other line-of-sight elevation provided at the target location for the quantum communication/quantum entanglement distribution. Upon receiving the reflected beam back from the corner-cube retroreflector 246, the reflected beam is collected using the periscope 240 and a telescope 250. In some aspects, the telescope 250 can be the same as or similar to the telescope 150 of FIG. 1. In some examples, the telescope 250 can be a compressing telescope. In some examples, the retroreflector 246 can be replaced by a mirror which points the reflected beam towards the receiver, for examples in scenarios or configurations when there is no line-of-sight to enable communication between a transmitting party and a receiving party.

From the telescope 250 (e.g., compressing telescope), the reflected beam can be subsequently passed through an optical bench setup of the entanglement distribution system 200, where the optical bench setup is configured to provide adaptive optics-based azimuthal phase compensation. For example, the optical bench setup of the entanglement distribution system 200 can include one or more (or all) of the mirror 254, the deformable mirror 256 (e.g., adaptive optics array or mirror, etc.), the beam splitter 258, wavefront sensor (WFS) 265, computing device 270, power meter 282, etc.

In some embodiments, the mirror 254 of FIG. 2 can be the same as or similar to the mirror 154 of FIG. 1; the deformable mirror 256 of FIG. 2 can be the same as or similar to the deformable mirror 156 of FIG. 1; the beam splitter 258 of FIG. 2 can be the same as or similar to the beam splitter 158 of FIG. 1; the WFS 265 of FIG. 2 can be the same as or similar to the WFS 165 of FIG. 1; the fiber coupler 262 of FIG. 2 can be the same as or similar to the fiber coupler 162 of FIG. 1; the WDM demultiplexer 285 of FIG. 2 can be the same as or similar to the WDM demultiplexer 185 of FIG. 1; the power meter 282 of FIG. 2 can be the same as or similar to the power meter 182 of FIG. 1; the computing device 270 of FIG. 2 can be the same as or similar to the computing device 170 of FIG. 1; etc.

The reflected beam after the AO-based compensation applied by the deformable mirror 256 is then split by the beam splitter 258 into a first and second reflected beam portion (e.g., the same as or similar to the beam splitting described with respect to the beam splitter 158 of FIG. 1), with the first split portion of the beam (e.g., the 8% beam portion) coupled into the WFS 265 for performing wavefront detection and measurement associated with an adaptive optics control algorithm or process implemented at the computing device 270 for controlling the deformable mirror(s) of the deformable mirror 256 adaptive optics. The second split portion of the beam (e.g., the 92% beam portion) is coupled into an optical fiber by the fiber coupler 262 and further passed through the WDM demultiplexer 285 to separate C-band quantum signals (e.g., associated with signal and idler entangled photons from the entangled source 210) and 1310 nm classical signals (e.g., associated with classical signal photons from the classical laser source 222).

The C-band quantum signal is further passed from the WDM demultiplexer 285 through a two-stage CCWDM demultiplexer 287 (e.g., which can be the same as or similar to the CCWDM demultiplexer 187 of FIG. 1), where the CCWDM demultiplexer 287 is configured to demultiplex idler photons (e.g., 1510 nm photons) and signal photons (e.g., 1590 photons) before sending the demultiplexed idler and signal photons to two separate ports of correlated single photon detector (SPD) system 290 for coincidence count measurements. In some embodiments, the correlated SPD system 290 of FIG. 2 can be the same as or similar to the correlated SPD system 190 of FIG. 1. Experiments are performed in strong atmospheric turbulence regime corresponding to or associated with the turbulent FSO link 245, e.g., as with the experiments performed in the strong atmospheric turbulence regime corresponding to or associated with the turbulent FSO link 145 of FIG. 1.

FIG. 3C is a graph 380 showing coincidence counts recorded on a CSPD (e.g., such as the CSPD 190 of FIG. 1 and/or the CSPD 290 of FIG. 2, etc.), under experimental conditions with and without application of adaptive optics over turbulent channels. For example, the graph 380 depicts a set of data points represented with open circles as corresponding to ‘noAO’ experimental conditions, without the application of the adaptive optics and wavefront correction/processing implemented by the deformable mirror 156,256 of FIGS. 1-2. The graph 380 further depicts a set of data points represented with shaded circles as corresponding to ‘withAO’ experimental conditions, where the adaptive optics and wavefront correction/processing implemented by the deformable mirror 156,256 of FIGS. 1-2 is utilized for the transmissions over the turbulent FSO link 145, 245 (respectively).

In particular, FIG. 3C provides illustrative results of coincidence counts on a CSPD after the round trip of 1.5 km over the experimental FSO link 145 used by and associated with the entanglement distribution system 100 of FIG. 1 and/or the FSO link 245 used by and associated with the entanglement distribution system 200 of FIG. 2, along with the improvements made from the azimuthal phase compensation applied through the use of adaptive optics on the deformable mirror 156 of FIGS. 1 and/or 256 of FIG. 2. Clear improvement from adaptive optics is shown, and these results indicate an improvement of 137.58% for the average coincidence count measurement.

Described below are approaches that can be used to implement multi-wavelength entanglement distribution (e.g., multipartite entanglement distribution) over turbulent FSO links with wavefront corrections from adaptive optics. For instance, FIG. 4 is a simplified diagram showing an example representation of an FSO experimental setup of an entanglement distribution system 400 for multipartite entanglement distribution over turbulent channels of an FSO link, in accordance with some examples.

In some embodiments, the multipartite entanglement distribution system 400 of FIG. 4 (or one or more components thereof) can be the same as or similar to the entanglement distribution system 100 of FIG. 1 (or a corresponding one or more components thereof) and/or can be the same as or similar to the entanglement distribution system 200 of FIG. 2 (or a corresponding one or more components thereof).

For example, the entangled source 410 of FIG. 4 can be the same as or similar to the entangled source 110 of FIGS. 1 and/or 210 of FIG. 2; the tunable laser 412, EDFA 414, and PPLN waveguide 416 of FIG. 4 can be the same as or similar to the tunable laser 112, EDFA 114, and PPLN waveguide 116 of FIG. 1 (respectively) and/or can be the same as or similar to the tunable laser 212, EDFA 214, and PPLN waveguide 216 of FIG. 2 (respectively). A classical laser source 422 and WDM multiplexer 425 of FIG. 4 can be the same as or similar to, respectively, the classical laser source 122 of FIGS. 1 and/or 222 of FIG. 2, and the WDM multiplexer 125 of FIGS. 1 and/or 225 of FIG. 2.

A beam expander 430 and periscope 440 of FIG. 4 can be the same as or similar to the beam expander 130 of FIGS. 1 and/or 230 of FIG. 2, and the periscope 140 and/or 240 of FIG. 2 (respectively). The turbulent FSO link 445 of FIG. 4 can be the same as or similar to the turbulent FSO link 145 of FIGS. 1 and/or 245 of FIG. 2. The corner-cube retroreflector 446 of FIG. 4 can be the same as or similar to the corner-cube retroreflector 146 of FIGS. 1 and/or 246 of FIG. 2.

A telescope 450 of FIG. 4 can be a compressing telescope, and may be the same as or similar to one or more of the telescopes 150 of FIG. 1 and/or the telescope 250 of FIG. 2. In some embodiments, the mirror 454 of FIG. 4 can be the same as or similar to the mirror 154 of FIGS. 1 and/or 254 of FIG. 2; the deformable mirror 456 of FIG. 4 can be the same as or similar to the deformable mirror 156 of FIGS. 1 and/or 256 of FIG. 2; the beam splitter 458 of FIG. 4 can be the same as or similar to the beam splitter 158 of FIGS. 1 and/or 258 of FIG. 2; the WFS 465 of FIG. 4 can be the same as or similar to the WFS 165 of FIGS. 1 and/or 265 of FIG. 2; the fiber coupler 462 of FIG. 4 can be the same as or similar to the fiber coupler 162 of FIGS. 1 and/or 262 of FIG. 2; the WDM demultiplexer 485 of FIG. 4 can be the same as or similar to the WDM demultiplexer 185 of FIGS. 1 and/or 285 of FIG. 2; the power meter 482 of FIG. 4 can be the same as or similar to the power meter 182 of FIGS. 1 and/or 282 of FIG. 2; the computing device 470 of FIG. 4 can be the same as or similar to the computing device 170 of FIGS. 1 and/or 270 of FIG. 2; etc.

In one illustrative example, the multipartite entanglement distribution system 400 of FIG. 4 can use the entangled source 410 to generate two or more entangled photon pairs, for instance using the PPLN waveguide 416, C-band laser diode 412, and EDFA 414. As illustrated in FIG. 4, the multipartite entanglement distribution system 400 can generate two entangled wavelength pairs (e.g., a total of four entangled wavelengths).

The generated entangled photon pairs from the multipartite entangled source 410 are transmitted over a turbulent FSO link 445, separated into different wavelength channels using compact coarse WDM demultiplexers (e.g., using the CCWDM demultiplexer 487 configured to separate the quantum portion of the reflected signal provided as a demultiplexed output separated from the 1310 nm classical portion of the reflected signal by the WDM demultiplexer 485), and subsequently provided for coincidence count measurements of four wavelength channels using a correlated photon detection system (e.g., the correlated SPD system 490).

In some aspects, the CCWDM demultiplexer 487 of FIG. 4 can be the same as or similar to the CCWDM demultiplexer 187 of FIG. 1 and/or the CCWDM demultiplexer 287 of FIG. 2. In some cases, the CCWDM demultiplexer 487 can be implemented using two instances of the CCWDM demultiplexer 187 of FIG. 1 and/or the CCWDM demultiplexer 287 of FIG. 2. For example, the CCWDM demultiplexer 487 separates the entangled photon pairs into four different wavelength output channels (shown in FIG. 4 as the separated 1530 nm and 1570 nm photons, and the separated 1510 nm and 1590 nm photons), while the CCWDM demultiplexer 187 of FIG. 1 and the CCWDM demultiplexer 287 each perform separation of entangled photons pairs into two different wavelength output channels. After separation of the entangled photon pairs into the four different wavelength output channels 1530 nm, 1510 nm, 1590 nm, 1570 nm by the CCWDM demultiplexer 487, the multipartite entanglement distribution system 400 of FIG. 4 can use a corresponding four detection ports of the correlated SPD system 490 to determine coincidence count measurements for the four wavelength channels from the CCWDM demultiplexer 487.

In some aspects, the systems and techniques disclosed herein can be used to improve the tolerance of an entanglement distribution system (e.g., such as the entanglement distribution system 100 of FIGS. 1, 200 of FIGS. 2, 400 of FIG. 4, etc.) to turbulence effects, based on the use of adaptive optics (AO) to compensate for turbulence and/or other effects (such as the pointing error and/or beam wandering effects, etc.) on the turbulent FSO link of the system, to thereby increase the resulting coincidence counts at a correlated SPD system. In one illustrative example, the multipartite entanglement distribution system 400 of FIG. 4 can use a 1.45 km long FSO link 445. To generate entangled photons, a relatively low-cost solution is provided, employing only C-band devices: a tunable laser 412, a high-power EDFA 414, and the periodically poled lithium niobate (PPLN) waveguide 416. Entangled photons are distributed over the turbulent FSO link 445 and after coupling to a fiber line, different wavelength channels are separated using a coarse WDM demultiplexer (CCWDM) 487, followed by a correlated photon detection system (e.g., CSPD system 490) to perform the coincidence measurements. The experimental results described herein for the entanglement distribution systems 100 of FIGS. 1, 200 of FIG. 2, and/or 400 of FIG. 4 indicate successful distribution of entangled photons over the atmospheric turbulence FSO link. To improve tolerance to turbulence effects the AO is used. Described below is the improvement in coincidence counts after applying the AO.

### Multi-Wavelength Entanglement Distribution-Experimental Testbed

To study entanglement distribution over turbulent FSO channels, the FSO testbed corresponding to the multipartite entanglement system 400 FIG. 4 can be used to transmit signals between a source location (e.g., ECE Quantum Communication Lab (Room 549) on the University of Arizona campus) and a destination/target location (e.g., the Meinel building of the College of Optical Sciences on the University of Arizona campus). However, in this scenario the corner-cube retroreflector 446 is placed on the roof of the Meinel building to double the transmission distance. Both the transmitter and receiver in this arrangement are placed in ECE Rm 549. This experiment has demonstrated that the entanglement can be distributed from one building to another building using the terrestrial turbulent FSO link 445. In some embodiments, the retro-reflector 446 can be replaced by a mirror or other reflector that can be used to point, redirect, relay, etc., the reflected beam towards a receiver or receiving party that does not have a line-of-sight to the transmitter or transmitting party, to thereby enable communication (e.g., entanglement distribution) between communicating parties without direct LOS therebetween.

In an alternative scenario the entanglement source 410 can be placed on a drone or a balloon (or space platform or satellite) and may be used to distribute the entanglement to various interested parties, receivers, etc., using corresponding FSO links from the entanglement source 410 (e.g., on the drone, balloon, satellite, etc.) to the intended or desired receiver. In these examples, the corner cube retroreflector 446 can be omitted, and the transmission can be performed in multiple directions of the FSO links towards different users (e.g., recalling that the retroreflector 446 was used in the FSO testbed setup for the multipartite entanglement system 400 in order to effectively double the length of the FSO link traversed by the entangled photons). In this scenario, the entangled source will be placed on the drone or high tower and multiple expanding telescopes can be used after the CCWDM demultiplexer 487 to point entangled photons to different destinations. In some embodiments, Low-Earth orbit (LEO) satellites or space platforms can also be used to distribute the entanglement, based on the LEO satellites or space platforms including the entanglement source 410 and corresponding transmitter-side components (e.g., the laser source 422, WDM multiplexer 425, beam expander 430, and/or periscope 440, etc.).

In some aspects, the experimental testbed of the multipartite entanglement distribution system 400 of FIG. 4 can be divided into five stages: a first stage for entangled photon pair generation; a second stage using an optical transceiver; a third stage using the FSO link; a fourth stage using an adaptive optics (AO) sub-system; and a fifth stage using single photon detectors (SPDs), each of which are described in turn below.

First Stage (e.g., entangled photon pair generation): in the first stage, the multipartite entanglement distribution system 400 can generate entangled photon pairs (e.g., multiple two-entangled wavelength pairs, for instance a total of four entangled wavelengths are provided in FIG. 4) using the entangled source 410. Entangled photon pairs can be generated using a tunable laser 412 tuned at 1548.97 nm, further amplified using a high-power EDFA 414, and a PPLN waveguide 416. The PPLN waveguide 416 generates entangled photon pairs by the process of parametric down-conversion (PDC).

Second Stage (e.g., optical transceiver stage): In the second stage of the multipartite entanglement distribution system 400, the output from the PPLN waveguide 416 (e.g., the “quantum signal” in FIG. 4) can be multiplexed with a 1310 nm laser signal (e.g., the “classical signal” from the laser source 422 in FIG. 4) using a WDM multiplexer 425. In some aspects, the second stage multiplexing of the quantum signal with the classical signal can be implemented because the quantum signals out of the PPLN waveguide 416 are extremely low power and may be impossible to detect using any conventional detector and power meter. Accordingly, the use of the second stage multiplexing of the quantum signal and the classical signal by the WDM multiplexer 425 can be beneficial in maintaining the link (e.g., the FSO link 445 used for the quantum communications), coupling the reflected/received signal into optical fiber (e.g., at the fiber coupler 462), and performing adaptive optics to compensate for turbulence or beam wandering effects on the FSO link 445 (e.g., using the deformable mirror 456, computing device 470, WFS 465, and/or power meter 482), as will be described in greater depth below. The output from the WDM multiplexer 425 is then fed to a beam expander 430 that transmits the beam into the free space (e.g., via the turbulent FSO link 445) using a periscope 440 to match the bench height with the window height.

Third Stage (e.g., FSO link stage): in the third stage of the multipartite entanglement distribution system 400, the FSO link 445 may be divided in two parts. For instance, the transmitter, receiver, and adaptive optics components of the multipartite entanglement distribution system 400 can be provided at the source location (e.g., located in ECE Room 549) and a retroreflector 446 can be provided at the intermediate or target location (e.g., placed on the roof-top of the optical science building). A similar concept can be applied when there is no line-of-sight between the source of entanglement and the destination, the intermediate mirror (e.g., retroreflector 446 in FIG. 4 can be replaced by a movable mirror pointing to a desired direction) will then point the beam carrying entangled photons towards the destination. The Tx/Rx portion and the retroflector portion of the example FSO experimental testbed using the multipartite entanglement distribution system 400 of FIG. 4 can be set up approximately 725 meters apart, giving the FSO link 445 a total link length of 1450 meters. The distance to the intermediate building can be changed by selecting a different intermediate building.

The transmitted beam out of the beam expander 430 then propagates towards the intermediate location (e.g., Meinel building) and gets reflected by the retroreflector 446 back towards the source location (e.g., ECE Rm 549 window). In this third stage (e.g., FSO link stage), the reflected beam from the retroreflector/mirror 446 at the intermediate location is received using the same periscope 440. The transmitted beam is from left to right in the perspective of FIG. 4, while the received beam is from right to left in the perspective of FIG. 4. The periscope system 440 can comprise three mirrors. A top mirror of the periscope 440 is common to both directions (e.g., is used for both transmitting and receiving beams/photons at the periscope 440). A small bottom mirror and the shared top mirror represent the transmit side of the periscope 440, while a separate/different, larger bottom mirror and the shared top mirror represent the receive side of the periscope 440.

In some embodiments, the compressing telescope 450 can include a regular lens at its end towards the periscope 440, and an objective lens at the opposite end of the compressing telescope 450 (e.g., the end of the compressing telescope 450 that is towards the mirror 454 shown on the left of the compressing telescope 450 in FIG. 4). In some respects, the fiber coupling sub-system 462 can include an objective lens for receiving the portion of the reflected/received beam from the beam splitter 458, which enables better matching to the fiber numerical aperture.

Fourth Stage (e.g., Adaptive Optics stage): In the fourth stage of the multipartite entanglement distribution system 400, an AO sub-system can be used to perform compensations for turbulence distortions on the FSO link 445. For instance, after exiting the compressing telescope 450, the received beam, (e.g., reflected beam) propagates over the optical bench with the AO setup (e.g., AO sub-system). The AO sub-system includes a wavefront sensor (WFS) 465 and a deformable mirror (DM) 456, operating in a servo loop controlled at least in part by the associated computing device 470. The WFS 465 can be used to look for (e.g., detect, measure, etc.) wavefront distortions in a portion of the received beam that is provided to the WFS 465 from the beam splitter 458 (e.g., the 8% portion of the beam split by the beam splitter 458).

For instance, the received beam can exit the compressing telescope 450, be reflected by a first mirror 454 to the deformable mirror 456 of the AO sub-system, and then provided to a beam splitter (BS) 458. The beam splitter 458 can split the beam between the fiber coupler 462 and the WFS 465 of the AO sub-system. In some embodiments, the beam splitter 458 can use a 92% to 8% split of the incoming beam, with 92% being provided to the fiber coupler 462 for coincidence count measurements at the correlated SPD system 490 and 8% being provided to the WFS 465 for wavefront distortion detection and implementation of corresponding corrections using the deformable mirror 456 of the AO sub-system.

Both portions of the beam after the beam splitter 458 (e.g., the 92% portion and the 8% portion) include both the quantum signal and classical signal. The 92% portion of the beam provided to the fiber coupler 462 for subsequent analysis and/or coincidence count measurements at the SPDs 490 is first separated into its constituent quantum signal components and classical signal components by the WDM demultiplexer 485. However, the 8% portion of the beam provided to the WFS 465 and the AO sub-system does not need to undergo demultiplexing to separate the quantum and classical signals, as the adaptive optics sub-system is not sensitive to the contribution of the quantum signal (i.e., may perform the adaptive optics compensation based on the classical signal component alone, as noted previously above).

While the correction or compensation applied by the AO sub-system (e.g., applied by the particular deformations implemented at the deformable mirror 456) are determined based on the classical signal component of the received beam, the quantum signal component of the received beam also benefits from the correction/compensation of the wavefront. Accordingly, it is contemplated that the inclusion of the classical signal multiplexed with the quantum signal can be used to probe the FSO turbulent channel 445 in order to determine an AO compensation that can be used to improve the quantum signal component of the received beam.

In particular, the WFS 465 can be used to identify one or more wavefront distortions in the portion of the received beam that is provided to the WFS 465. One or more computing devices 470 coupled to the WFS 465 can subsequently be used to calculate the corresponding correction signals for the one or more wavefront distortions identified by the WFS 465. The corresponding correction signals calculated by the computing device 470 can be applied to deform the deformable mirror 456 in order to compensate for the wavefront distortions. In one illustrative example, the multipartite entanglement distribution system 400 of FIG. 4 can perform greater than 350 AO corrections per second.

In some embodiments, the 1310 nm classical signal from the classical laser source 422 (e.g., the classical signal that was earlier multiplexed together by the WDM multiplexer 425 with the entangled photons (e.g., the quantum signal from the PPLN waveguide 416)) can be used as a beacon laser signal for implementing the adaptive optics. For instance, the 1310 nm classical signal can be used as a beacon laser signal for performing AO based on the 1310 nm classical signal being powerful enough for the WFS 465 to function (which otherwise is difficult to achieve with the quantum signal alone).

Fifth Stage (e.g., photon detection stage): In the fifth stage of the multipartite entanglement distribution system 400, photon detection can be performed. For instance, single photon detection can be performed using one or more single photon detectors (SPDs) of the correlated SPD system 490. In some embodiments, the multipartite entanglement distribution system 400 of FIG. 4 can include, within the correlated SPD system 490, a respective SPD corresponding to each entangled photon (wavelength) of a plurality of entangled photons (wavelengths) generated at the first stage/photon generation stage.

As illustrated in FIG. 4, after the AO stage/fourth stage, the remaining portion of the reflected beam after the beam splitter 458 (e.g., the remaining 92% of the reflected beam) is coupled into the optical fiber by the fiber coupler 462 and then demultiplexed into individual wavelength channels using a two-stage cascade of WDM demultiplexers 485 and 487.

First, the 1310 nm classical reference signal can be separated from entangled photons by the WDM demultiplexer 485. Subsequently, the entangled photons can be provided from the WDM demultiplexer 485 as a first demultiplexed output that is then further separated into different wavelengths of entangled photons using two stages of compact coarse WDM (CCWDM) demultiplexers 487.

From the available wavelength channels on the CCWDMs 487, the entangled photon pairs can be selected. For instance, in the context of the present example experiment, 1590 nm-1510 nm entangled photon pairs and 1530 nm-1570 nm entangled photon pairs can be chosen from the available wavelength channels on the CCWDMs 487. Given that the parametric down conversion process bandwidth is very large (e.g., over 100 nm), a large number of entangled wavelengths can be distributed using the multipartite entanglement distribution system 400 of FIG. 4 and/or using the systems and techniques described herein.

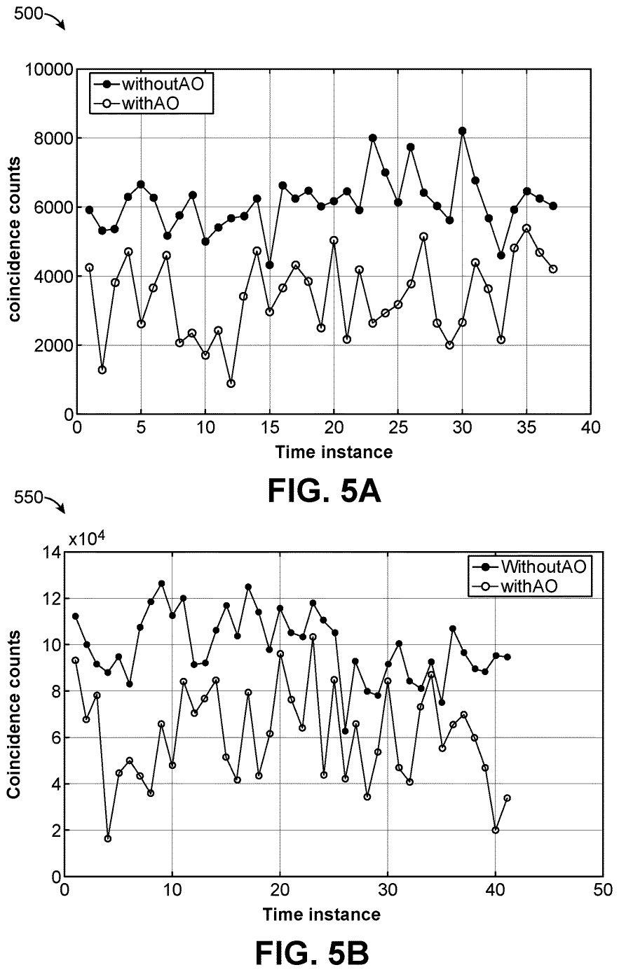

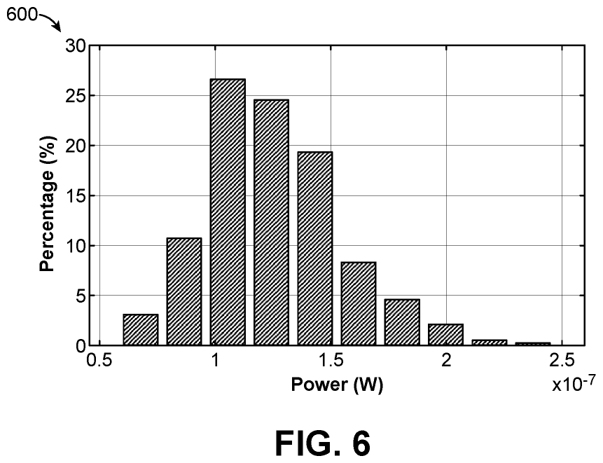

In some aspects, the CCWDM demultiplexer 487 output wavelengths can be used to determine the tuning wavelength of the pump laser (e.g., tunable laser 412 of the entangled source 410) included in the multipartite entanglement distribution system 400 of FIG. 4. The four outputs from the CCWDM demultiplexers 487 are subsequently fed to a corresponding four input ports of a correlated photon detection system 490 composed of four single photon detectors (SPDs) and corresponding electronics for the coincidence measurements. The results of coincidence measurements are captured and analyzed with relevant results described below with respect to FIGS. 5 and 6.

### Multi-Wavelength Entanglement Distribution—Experimental Results

FIG. 5A is a graph 500 showing coincidence count measurement results for 1510 nm-1590 nm entangled photon pairs after 1.45 km propagation over a turbulent FSO link, in accordance with some examples. For instance, FIG. 5A summarizes the results for coincidence count measurements for the 1510 nm and 1590 nm entangled photon pairs over the turbulent FSO link 445 of FIG. 4. The experimental results indicate that entanglement can be distributed over atmospheric turbulent FSO channels. To improve the tolerance to turbulence effects the AO system is used. The improvements made in coincidence count measurements with the application of adaptive optics can be clearly seen in FIG. 5A.

FIG. 5B is a graph 550 showing coincidence count measurement results for 1530 nm-1570 nm entangled photon pairs after 1.45 km propagation over a turbulent FSO link 445, in accordance with some examples. For instance, FIG. 5B summarizes the coincidence count measurement results for 1530 nm and 1570 nm entangled photon pairs that are co-propagated along with 1510 nm and 1590 nm entangled photon pairs. Similar to the results presented in graph 500 of FIG. 5A, the results presented in graph 550 of FIG. 5B demonstrate that multi-wavelength entanglement distribution over turbulent FSO links is achieved. The coincidence counts for 1530 nm-1570 nm entangled photons are higher because of more favorable Mie scattering channel conditions. The use of adaptive optics, similar to as in FIG. 5A, is seen in FIG. 5B to provide improvements in coincidence count measurements.

The multi-wavelength entanglement distribution experimental results described above are performed/obtained under a strong turbulence regime (e.g., associated with the turbulent FSO link 445 of FIG. 4), as indicated in FIG. 6, which is a graph 600 showing a distribution of received power at 1310 nm. From FIG. 6, it can be seen that the distribution of the received power in a histogram plot follows a Rayleigh distribution, indicating that turbulence conditions were strong.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto. To illustrate, in an alternative scenario the entanglement source can be placed on a drone or a balloon and distribute the entanglement to the interested parties. LEO satellites or space platforms can also be used to distribute the entanglement.

What is claimed is:

1. An apparatus comprising:
a tunable laser configured to generate a beam at a first wavelength;
an amplifier coupled to an output of the tunable laser, wherein the amplifier generates as output an amplified beam at the first wavelength and with an increased power; and
a periodically poled lithium niobate (PPLN) waveguide configured to receive the amplified beam from the amplifier and generate one or more entangled pairs of photons, each entangled pair of photons comprising a signal photon and an idler photon, wherein the PPLN waveguide generates the one or more entangled pairs of photons using spontaneous parametric down-conversion (SPDC).

2. The apparatus of claim 1, wherein the tunable laser comprises a C-band laser diode and the amplifier comprises an Erbium-Doped Fiber Amplifier (EDFA).

3. The apparatus of claim 1, wherein:
the first wavelength is associated with a combination of the tunable laser and the EDFA and is equal to 1548.97 nanometers (nm);
the signal photon has a wavelength of 1510 nm; and
the idler photon has a wavelength of 1590 nm.

4. The apparatus of claim 1, wherein:
the PPLN waveguide includes one or more graded index lenses on a first side and a second side of the PPLN waveguide; and
the one or more graded index lenses are configured to provide a coupling to polarization maintaining fibers without using a fiber-to-crystal coupling.

5. The apparatus of claim 1, wherein:
a first half of the PPLN waveguide along its longitudinal length is used to perform wavelength conversion of the amplified beam; and
a second half of the PPLN waveguide along the longitudinal length is used to perform the SPDC.

6. The apparatus of claim 1, the apparatus further comprising:
a second laser configured to generate a second beam at a second wavelength, wherein the second wavelength differs by a configured amount from the first wavelength associated with the tunable laser;
a multiplexer configured to generate a multiplexed signal based on combining a classical signal comprising the second beam at the second wavelength with a quantum signal comprising an output from the PPLN waveguide at the first wavelength of the tunable laser; and
an optical transmitter for transmitting a beam including the multiplexed signal generated by the multiplexer.

7. The apparatus of claim 6, wherein the multiplexed signal comprises a beam that includes a classical component corresponding to the classical signal and a quantum component corresponding to the quantum signal.

8. The apparatus of claim 6, wherein the second wavelength is 1310 nanometers (nm).

9. The apparatus of claim 6, wherein the multiplexer implements wavelength-division multiplexing (WDM).

10. The apparatus of claim 6, the apparatus further comprising:
a receiver for receiving one or more of a reflected beam from an intermediate node, or a receive beam from a transmitter;
wherein the reflected beam comprises a reflection of the transmitted beam by a mirror or reflector located at the intermediate node.

11. The apparatus of claim 10, wherein:
the receive beam comprises the transmitted beam from the optical transmitter after propagation over a turbulent free-space optical (FSO) channel between the optical transmitter and the receiver.

12. The apparatus of claim 10, wherein the receiver comprises a periscope and a compressing telescope, and wherein the periscope is included in the optical transceiver.

13. The apparatus of claim 10, the apparatus further comprising:
an adaptive optics (AO) sub-system, wherein the AO sub-system receives a portion of the reflected beam from the intermediate node or a direct beam from a remote transmitter and determines a correction for applying to a deformable mirror to compensate for turbulence on a free-space optical (FSO) link between the optical transmitter and the optical receiver; and
a deformable mirror, wherein the deformable mirror is controllable to receive a remaining portion of the reflected beam and deform based on the correction determined by the AO sub-system, and wherein the deformation of the deformable mirror generates a compensated reflected beam.

14. The apparatus of claim 13, wherein:
the AO sub-system includes a wavefront sensor (WFS), the deformable mirror, and a computing device; and
the WFS and the deformable mirror operate in a feedback servo loop.

15. The apparatus of claim 13, wherein the apparatus further includes:
a first demultiplexer configured to separate the classical signal component of the compensated reflected beam from the quantum signal component of the compensated reflected beam;
a second demultiplexer configured to separate the entangled photons of the quantum signal component; and
one or more detectors for detecting each separated entangled photon.

16. The apparatus of claim 15, wherein:
the first demultiplexer comprises a wavelength-division (WDM) demultiplexer;
the second demultiplexer comprises a two-stage compact coarse WDM (CCWDM) demultiplexer; and
the one or more detectors are correlated single photon detectors (SPDs).

17. The apparatus of claim 1, wherein an operating wavelength of the tunable laser is selected:
based on a tunable pump wavelength, a signal photon wavelength, and an idler photon wavelength; or
according to 2/λₚ=1/λₛ+1/λᵢ), where λₚ is a tunable pump wavelength, λₛ is a signal photon wavelength, and λᵢ is an idler photon wavelength.

18. The apparatus of claim 17, wherein:
the idler photon wavelength (λᵢ) is 1510 nanometers (nm) and the signal photon wavelength (λₛ) is 1590 nm; and
the tunable pump wavelength is determined as 1548.97 nm based on the idler photon wavelength and the signal photon wavelength.

19. The apparatus of claim 17, wherein the tunable laser includes a tunable pump that can be used to generate multi-wavelength entangled pairs, and wherein the tunable pump wavelength of 1549.75 nm and idler photon wavelengths of 1510 nm and 1530 nm are used to determine signal photon wavelengths of 1591.65 nm and 1570 nm, respectively.

20. The apparatus of claim 19, wherein the tunable pump wavelength of 1548.97nm and an idler photon wavelength of 1568 nm are used to determine a signal photon wavelength of 1530.39 nm.
